(19) United States
(12) Patent Application Publication
(10) Pub. No.: US 2014/0267944 A1
(43) Pub. Date: Sep. 18, 2014

(54) OPTICALLY TRANSPARENT FILM COMPOSITES

(71) Applicant: FiftyThree Inc., New York, NY (US)

(72) Inventors: John K. IKEDA, Seattle, WA (US); Jonathan R. HARRIS, Redmond, WA (US); Thomas C. ARENDS, Bellevue, WA (US); Nicholas E. BRATT, Edmonds, WA (US); Georg F. PETSCHNIGG, New York, NY (US)

(21) Appl. No.: 13/830,820

(22) Filed: Mar. 14, 2013

(51) Int. Cl. G06F 3/041; G02B 5/02; G02B 5/20; G02F 1/1333; G02B 1/10

(52) U.S. Cl. CPC G06F 3/041; G02F 1/13338; G02B 1/10; G02B 5/208; G02B 5/0278; G02B 1/105
USPC 349/12; 359/893; 359/350; 359/615; 359/361; 359/884

(57) ABSTRACT

The present invention relates to electronic drawing systems and films useful for the same. Specifically, the present invention relates to films, devices, methods, systems and combinations for electronic drawing systems.

### FIELD OF THE INVENTION

The present invention relates to electronic drawing systems and films useful for the same. Specifically, the present invention relates to films, devices, methods, systems and combinations for electronic drawing systems.

### BACKGROUND

Electronic drawing systems can be employed to digitally record and display freehand drawings or writing. Strokes by handheld devices such as an electronic pen or stylus on a drawing surface can be digitally recorded by optical tracking systems contained within such devices. The optical tracking systems typically include miniaturized cameras or sensors that can digitally record the electronic pen or stylus strokes on the drawing surface. Such optical tracking systems detect a pattern of dots on the drawing surface to determine the position of the electronic pen or stylus on the drawing surface. Such systems typically display pen strokes on the drawing surface on a display screen in electronic communication with the optical tracking system. However, such electronic drawing systems require a drawing surface upon which the strokes of the electronic pen or stylus are registered, and a separate display screen where such strokes are shown.

However, many electronic drawing systems users can find the need for both a drawing surface and a display screen inconvenient and inefficient; for example, users who wish to employ an electronic drawing system on a hand-held electronic device. Accordingly, there is a need for an electronic drawing system which does not require a drawing surface and a separate display screen.

### SUMMARY OF THE INVENTION

The present invention provides a film comprising a substrate and a light-interacting pattern, wherein the film is substantially transparent to visible light.

The present invention further provides a system, comprising a computer or hand-held electronic device, the computer or hand-held device comprising a display screen, the display screen comprising a touch-sensitive screen; and a film comprising a substrate and a light-interacting pattern, wherein the film is substantially transparent to visible light.

The present invention also provides a computer or hand-held electronic device, comprising a display screen, the display screen comprising a touch-sensitive screen; and a film, comprising a substrate and a light-interacting pattern, wherein the film is substantially transparent to visible light, and wherein the film is adhered to the touch-sensitive screen.

The present invention further provides a computer system, comprising a film comprising a substrate and a light-interacting pattern, wherein the film is substantially transparent to visible light; a computer or hand-held electronic device, the computer or hand-held device comprising a display screen, the display screen comprising a touch-sensitive screen; a stylus configured to emit light to and detect light scattered by or reflected from the light-interacting pattern of the film; and a transmitting device, the transmitting device being coupled to the stylus and configured to transmit data from the stylus to the computer or hand-held electronic device.

The present invention also provides a method for transmitting data from a stylus to a computer or hand-held device, comprising allowing a stylus to emit light to and detect light scattered by or reflected from the light-interacting pattern of a film comprising a substrate and a light-interacting pattern, wherein the film is substantially transparent to visible light, the film being adhered to a touch-sensitive screen of a computer or hand-held electronic device, and the stylus being coupled to a transmitting device; and allowing the transmitting device to transmit data from the stylus to the computer or hand-held electronic device.

The present films, devices, methods, systems and combinations and advantages thereof, are further illustrated by the following non-limiting detailed description, Figures and Examples.

### BRIEF DESCRIPTION OF THE DRAWINGS

FIG. 1 is a plot of the absorption and emission spectra of a first illustrative photoactive compound.

FIG. 2 is a plot of the absorption spectrum of a second illustrative photoactive compound.

FIG. 3 is a plot of the emission spectrum of a second illustrative photoactive compound.

FIG. 4 is a schematic of an illustrative convex dot in a light-interacting pattern disposed on a substrate of the present invention.

FIG. 5 is schematic of a cross-sectional view of a portion of an illustrative film of the present invention.

FIG. 6 is schematic of a cross-sectional view of a portion of another illustrative film of the present invention.

FIG. 7 is schematic of a cross-sectional view of a portion of another illustrative film of the present invention.

FIG. 8 is schematic of a cross-sectional view of a portion of another illustrative film of the present invention.

FIG. 9 is schematic of a cross-sectional view of a portion of another illustrative film of the present invention.

### DETAILED DESCRIPTION OF THE INVENTION

The word “about” when immediately preceding a numerical value means a range of plus or minus 10% of that value, e.g., “about 50” means 45 to 55, “about 25,000” means 22,500 to 27,500, etc. Furthermore, the phrases “less than about” a value or “greater than about” a value should be understood in view of the definition of the term “about” provided herein.

Films as described herein can be used in, e.g., electronic drawing systems with a stylus or pen comprising an optical tracking system.

In a first aspect, the present invention provides a film comprising a substrate and a light-interacting pattern, wherein the film is substantially transparent to visible light. In some embodiments, the substrate comprises a polymer. The polymer can be selected in view of one or more properties, e.g., transparency, mechanical strength, heat resistance, chemical resistance, and durability.

In some embodiments, the polymer is biaxially stretched polyester. The biaxially stretched polyester sheet can be obtained by condensation polymerization of one or more diols and one or more dicarboxylic acids. Representative diols can include ethylene glycol, trimethylene glycol, tetramethylene glycol, cyclohexane dimethanol, and mixtures thereof. Representative dicarboxylic acids include terephthalic acid, isophthalic acid, phthalic acid, naphthalene dicarboxylic acid, adipic acid, sebacic acid and mixtures thereof. Illustrative polyesters can include polymethylene terephthalate, polyethylene terephthalate, polytetramethylene terephthalate, polyethylene-p-oxybenzoate, poly-1,4-cyclohexanedimethyl-ene terephthalate, polyethylene-2,6-naphthalate and mixtures thereof.

The polymer can comprise additives to provide desired properties or characteristics. For example, a polymer can comprise a thermoplastic polyester elastomer (TPE) to increase the polymer's rigidity. The polymer can comprise other known additives, for example, antioxidants or antistatic agents, crystal nucleation agents, inorganic particles, organic particles, and pigments. TPE or other additives can be blended in a polymerization mixture.

A substrate comprising biaxially stretched polyester can be obtained by forming a polyester sheet by, e.g., melt-extrusion or injection molding to obtain a polyester sheet, then biaxially stretching the sheet. By performing such biaxial stretching, polymer molecules are oriented biaxially and the sheet can acquire desired properties as described above. The stretch ratio is typically from 2 to 20 times, e.g., the polymer is stretched to a length, width, or both that is from 2 to 20 times its original length, width, or both.

In other embodiments, the substrate can comprise a polycarbonate, an acrylic polymer, a polyolefin (e.g., polypropylene, polymethylpentene, or a cyclic polyolefin), a polyamide (e.g., nylon 6), a polyacetal, polyphenylene oxide, polyether sulfone, polystyrene, a polyether, a polyether ketone, a polyepoxide, a polyimide, or combinations thereof. Further, each of the above polymers, or combinations thereof, can be combined with the one or more polyesters as described above, to form the substrate. Laminates of any of the polyesters and polymers, or combinations thereof, can also be employed to form the substrate.

The substrate can have a thickness of from about 10 μm to about 250 μm. For example, in some embodiments, the substrate has a thickness of about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about 105 μm, about 110 μm, about 115 μm, about 120 μm, about 125 μm, about 130 μm, about 135 μm, about 140 μm, about 145 μm, about 150 μm, about 155 μm, about 160 μm, about 165 μm, about 170 μm, about 175 μm, about 180 μm, about 185 μm, about 190 μm, about 195 μm, about 200 μm, about 205 μm, about 210 μm, about 215 μm, about 220 μm, about 225 μm, about 230 μm, about 235 μm, about 240 μm, about 245 μm, about 250 μm, or any other value or range of values therein.

The substrate can have a uniform thickness. For example, the thickness of the substrate can vary less than about ±10%, less than about ±9%, less than about ±8%, less than about ±7%, less than about ±6%, less than about ±5%, less than about ±4%, less than about ±3%, less than about ±2%, less than about ±1%, less than about ±0.5%, less than about ±0.1%, or any other value or range of values therein or therebelow).

In certain embodiments, the substrate is substantially transparent to visible light. “Substantially transparent to visible light” means that substantially all light in the visible spectrum, e.g., light having a wavelength of from about 400 nm to about 700 nm, passes through the substrate. A substrate which is about X % transparent to visible light allows about X % of incident light having a wavelength of from about 400 nm to about 700 nm to pass through the substrate. In some embodiments, the substrate that is substantially transparent to visible light can be greater than about 99% transparent to visible light, about 99% transparent to visible light, about 98% transparent to visible light, about 97% transparent to visible light, about 96% transparent to visible light, about 95% transparent to visible light, about 94% transparent to visible light, about 93% transparent to visible light, about 92% transparent to visible light, about 91% transparent to visible light, about 90% transparent to visible light, about 89% transparent to visible light, about 88% transparent to visible light, about 87% transparent to visible light, about 86% transparent to visible light, about 85% transparent to visible light, about 84% transparent to visible light, about 83% transparent to visible light, about 82% transparent to visible light, about 81% transparent to visible light, about 80% transparent to visible light, about 79% transparent to visible light, about 78% transparent to visible light, about 77% transparent to visible light, about 76% transparent to visible light, about 75% transparent to visible light, about 74% transparent to visible light, about 73% transparent to visible light, about 72% transparent to visible light, about 71% transparent to visible light, about 70% transparent to visible light, or any other value or range of values therein.

In some embodiments, the light-interacting pattern comprises a plurality of fiducials. “Fiducials” as used herein are structures that can be detected by a device as described herein (e.g., an electronic pen or stylus comprising an optical tracking system).

In some embodiments, the fiducials have spherical cap (e.g., a “convex dot”) geometry. In other embodiments, the fiducials have parallelepiped geometry. In certain embodiments, the fiducials have rectangular prism geometry. In other embodiments, the fiducials have a cylindrical geometry. In still other embodiments, the fiducials have a cubic geometry.

The fiducials in the light-interacting pattern can be disposed on a surface of the substrate. Thus, in one embodiment, the fiducials are disposed on a top surface of the substrate. In other embodiments, the fiducials are disposed on a bottom surface of the substrate.

In some embodiments, the fiducials have a substantially circular plan geometry. A “substantially circular plan geometry” means that from a plan view, the length of the radius of the circle formed by a fiducial varies less than about ±10%, about ±9%, about ±8%, about ±7%, about ±6%, about ±5%, about ±4%, about ±3%, about ±2%, about ±1%, or less than about ±1%. Spherical cap, convex dot and cylindrical fiducials can each have a substantially circular plan geometry.

In some embodiments, the fiducials are convex dots, and each convex dot has an average diameter of from about 40 μm to about 150 μm. In some embodiments, each of the convex dots has an average diameter of about 45 μm, about 50 μm, about 55 μm, about 60 μm, about 65 μm, about 70 μm, about 75 μm, about 80 μm, about 85 μm, about 90 μm, about 95 μm, about 100 μm, about 105 μm, about 110 μm, about 115 μm, about 120 μm, about 125 μm, about 130 μm, about 135 μm, about 140 μm, about 145 μm, about 150 μm, or any other value or range of values therein.

In some embodiments, the fiducials have a cylindrical geometry, and each cylindrical fiducial has an average diameter of from about 40 μm to about 150 μm. In some embodiments, each of the cylindrical fiducials has an average diameter of about 45 μm, about 50 μm, about 55 μm, about 60 μm, about 65 μm, about 70 μm, about 75 μm, about 80 μm, about 85 μm, about 90 μm, about 95 μm, about 100 μm, about 105 μm, about 110 μm, about 115 μm, about 120 μm, about 125 μm, about 130 μm, about 135 μm, about 140 μm, about 145 μm, about 150 μm, or any other value or range of values therein.

In some embodiments, the fiducials have a parallelepiped geometry, and each side of the parallelepiped fiducial independently has an average length of from about 40 μm to about 150 μm. In some embodiments, each side of the parallelepiped fiducials independently has an average length of about 45 μm, about 50 μm, about 55 μm, about 60 μm, about 65 μm, about 70 μm, about 75 μm, about 80 μm, about 85 μm, about 90 μm, about 95 μm, about 100 μm, about 105 μm, about 110 μm, about 115 μm, about 120 μm, about 125 μm, about 130 μm, about 135 μm, about 140 μm, about 145 μm, about 150 μm, or any other value or range of values therein.

In some embodiments, the fiducials have a rectangular prism geometry, and each side of the rectangular prism independently has an average length of from about 40 μm to about 150 μm. In some embodiments, each side of the rectangular prism independently has an average length of about 45 μm, about 50 μm, about 55 μm, about 60 μm, about 65 μm, about 70 μm, about 75 μm, about 80 μm, about 85 μm, about 90 μm, about 95 μm, about 100 μm, about 105 μm, about 110 μm, about 115 μm, about 120 μm, about 125 μm, about 130 μm, about 135 μm, about 140 μm, about 145 μm, about 150 μm, or any other value or range of values therein).

In some embodiments, the fiducials have a cubic geometry, and each side of the cube has an average length of from about 40 μm to about 150 μm. In some embodiments, each side of the cube independently has an average length of about 45 μm, about 50 μm, about 55 μm, about 60 μm, about 65 μm, about 70 μm, about 75 μm, about 80 μm, about 85 μm, about 90 μm, about 95 μm, about 100 μm, about 105 μm, about 110 μm, about 115 μm, about 120 μm, about 125 μm, about 130 μm, about 135 μm, about 140 μm, about 145 μm, about 150 μm, or any other value or range of values therein.

In some embodiments, the fiducials have a height of from about 5 μm to about 30 μm. In some embodiments, the fiducials have an average height of about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, or any other value or range of values therein. In some embodiments, the fiducials are convex dots, and each of the convex dots has an average height of about 5 μm to about 20 μm. In some embodiments, the fiducials are convex dots, and each of the convex dots has an average height of about 9 μm.

In some embodiments, the ratio of the average height of the fiducials to the average length, width or diameter the fiducials is from about 1:10 to about 1:1. In some embodiments, the ratio of the average height of the fiducials to the average length, width or diameter the fiducials is from about 1:10, about 1:9, about 1:8, about 1:7, about 1:6, about 1:5, about 1:4, about 1:3, about 1:2, about 1:1. In some embodiments, the fiducials are convex dots, and the ratio of the average height of the convex dots to the average diameter the convex dots is from about 1:10 to about 1:4. In some embodiments, the fiducials are convex dots, and the ratio of the average height of the convex dots to the average diameter the convex dots is from about 1:10, about 1:9, about 1:8, about 1:7, about 1:6, about 1:5, about 1:4.

The light-interacting pattern of the present film comprises fiducials which can have a spatial density of from about 10 dots per inch (dpi) to about 300 dpi. For example, the spatial density of the fiducials can be about 10 dpi, about 20 dpi, about 30 dpi, about 40 dpi, about 50 dpi, about 60 dpi, about 70 dpi, about 80 dpi, about 90 dpi, about 100 dpi, about 110 dpi, about 120 dpi, about 130 dpi, about 140 dpi, about 150 dpi, about 160 dpi, about 170 dpi, about 180 dpi, about 190 dpi, about 200 dpi, about 210 dpi, about 220 dpi, about 230 dpi, about 240 dpi, about 250 dpi, about 260 dpi, about 270 dpi, about 280 dpi, about 290 dpi, about 300 dpi, or any other value or range of values therein.

In some embodiments, the average spacing between each fiducial is from about 100 μm to about 400 μm. For example, in some embodiments, the average spacing between each fiducial is about 100 μm, about 110 μm, about 120 μm, about 130 μm, about 140 μm, about 150 μm, about 160 μm, about 170 μm, about 180 μm, about 190 μm, about 200 μm, about 210 μm, about 220 μm, about 230 μm, about 240 μm, about 250 μm, about 260 μm, about 270 μm, about 280 μm, about 290 μm, about 300 μm, about 310 μm, about 320 μm, about 330 μm, about 340 μm, about 350 μm, about 360 μm, about 370 μm, about 380 μm, about 390 μm, about 400 μm, or any other value or range of values therein. In some embodiments, the fiducials are convex dots, and the average spacing between each convex dot is about 300 μm.

In certain embodiments, fiducials as described herein comprise a carrier and a photoactive compound. The carrier can comprise an organic polymer, an inorganic polymer, a polysiloxane polymer, or mixtures thereof. For example, in some embodiments, the organic polymer is an acrylic polymer. Illustrative acrylic polymers can be formed by the polymerization of one or more acrylic monomers, which can be present in the carrier and subsequently polymerized. In some embodiments, acrylic monomers can include, e.g., methyl acrylate, methyl methacrylate, ethyl acrylate, isopropyl acrylate, butyl acrylate, propyl methacrylate, ethoxyethyl acrylate, methoxyethyl acrylate, methoxyethyl methacrylate, ethoxyethyl methacrylate, butyl methacrylate, isobutyl methacrylate, lauryl acrylate, stearyl acrylate, acrylic acid, methacrylic acid, butanedioc acid, ethylene acetate, propylene acetate, vinyl acetate, vinyl toluene, styrene, butadiene, isoprene, isobutylene, acrylonitrile, methacrylonitrile, and mixtures thereof. In some embodiments, the acrylic polymer is poly(methyl acrylate), poly(methyl methacrylate), poly(ethyl acrylate), poly(isopropyl acrylate), poly(butyl acrylate), poly(propyl methacrylate), poly(ethoxyethyl acrylate), poly(methoxyethyl acrylate), poly(methoxyethyl methacrylate), poly(ethoxyethyl methacrylate), poly(butyl methacrylate), poly(isobutyl methacrylate), poly(lauryl acrylate), poly(stearyl acrylate), poly(acrylic acid), poly(methacrylic acid), poly(butanedioic acid), poly(ethylene acetate), poly(propylene acetate), poly(vinyl acetate), poly(vinyl toluene), polystyrene, polybutadiene, polyisoprene, polyisobutylene, polyacrylonitrile, polymethacrylonitrile, or mixtures thereof. In some embodiments, the carrier can comprise a polycarbonate, an acrylic polymer, a polyolefin (e.g., polypropylene, polymethylpentene, or a cyclic polyolefin), a polyamide (e.g., nylon 6), a polyacetal, polyphenylene oxide, polyether sulfone, polystyrene, a polyether, a polyether ketone, a polyepoxide, a polyimide, or combinations thereof. In some embodiments, the carrier can also include additives that impart desired properties during or after the formation of the fiducials. For example, in some embodiments, the additives can include one or more of a defoamer, a dispersing agent, a biocide, a rheology modifier, and a wetting agent.

When the carrier is a polymer, the polymer can be formed prior to placement or formation of the fiducials, or alternatively, in some embodiments, the polymer can be formed during and/or after placement or formation of the fiducials. Thus, in some embodiments, one or more monomers (e.g., as described above) can be combined with a solvent and one or more photoactive compounds, and deposited on a surface of a substrate. In such embodiments, the mixture of momoner(s) solvent(s) and photoactive compound(s) can also include a polymerization initiator, such as a photo- or thermally-activated polymerization initiator (e.g., azobisisobutyronitrile, organic or inorganic peroxides).

The fiducials can be formed by admixing a carrier and a photoactive compound, optionally with a solvent and one or more additives (e.g., as described above), to form a mixture that can, in some embodiments, be deposited on the substrate. In some embodiments, the fiducials are formed by printing or coating the mixture on the substrate, then drying or heating the fiducials to, e.g., remove the solvent when present; to cure the fiducials; or to polymerize monomers in the carrier. In embodiments where the carrier is a polymer, and the polymer is formed during or after the deposition process, the carrier can comprise monomers that can be irradiated with, e.g., UV light, to initiate polymerization of the monomers in the carrier. Solvents suitable for the formation of the fiducials are not particularly limited. A solvent can be selected such that it is inert to the polymerization of carrier monomers. Suitable solvents for polyester formation are suitable for use in forming the present light-interacting pattern.

Fiducial formation or placement, e.g., deposition, on the substrate can be effected by inkjet printing, screen printing, gravure printing, offset printing, flexographic printing, spray-coating, slit coating, extrusion coating, meniscus coating, microspotting, pen-coating, stenciling, stamping, syringe dispensing and/or pump dispensing the mixture onto the substrate.

Forming the fiducials on the substrate thus can include printing a mixture comprising the carrier, one or more photoactive compounds and optionally one or more solvents and one or more additives (e.g., as described above) to form a pattern of fiducials, and drying or curing the pattern by heating. The fiducial pattern can be heated at a temperature of from about 25° C. to about 140° C. In some embodiments, the fiducial pattern can be heated at a temperature of about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 105° C., about 110° C., about 115° C., about 120° C., about 125° C., about 130° C., about 135° C., about 140° C. In some embodiments, the fiducial pattern can be heated for a length of time effective to remove the solvent and/or to polymerize the carrier. For example, in some embodiments, the fiducial pattern can be heated for about 1 minute, about 2 minutes, about 3 minutes, about 4 minutes, about 5 minutes, about 10 minutes, about 20 minutes, about 30 minutes, about 40 minutes, about 50 minutes, about 60 minutes, about 90 minutes, about 120 minutes, about 150 minutes, about 180 minutes, about 270 minutes, about 360 minutes, or any other value or range of values therein.

In some embodiments, printing, placing or otherwise depositing the mixture can be accompanied by irradiation with light (e.g., UV light), generally at a wavelength and/or in an intensity and for a duration effective to cure, polymerize or cross-polymerize carrier monomers, in embodiments wherein the carrier is deposited as one or more monomers. Irradiation can occur contemporaneously with or subsequent to printing, placing or depositing the mixture. Irradiation can also improve adhesion of the fiducials to the substrate, and/or improve the fiducial morphology (e.g., provide a desired plan geometry or cross-sectional shape).

In some embodiments, the carrier has an index of refraction of from about 1.1 to about 1.5. In some embodiments, the carrier has an index of refraction of from about 1.10, about 1.15, about 1.2, about 1.25, about 1.3, about 1.35, about 1.4, about 1.55, or about 1.5.

In certain embodiments, the fiducials comprise one or more photoactive compounds. The photoactive compound(s) can absorb particular wavelengths of light, and emit light responsive to the absorption of light. The specific structure of the photoactive compounds is not particularly important, insofar as the compound is capable of absorbing and emitting light at desired wavelengths. In some embodiments, the photoactive compounds are sufficiently soluble in the carrier and/or solvent employed in the deposition of the fiducials to allow for uniform mixing and dissolution or dispersion of the compound(s) in the carrier. Thus, in some embodiments, the photoactive compound is dissolved in or dispersed substantially uniformly throughout the carrier.

In other embodiments, the photoactive compound is provided as a particulate material which is substantially insoluble in the carrier and/or solvent employed in the deposition of the fiducials. For example, in some embodiments, the photoactive compound is in the form of particles which have an average particle size of from about 100 nm to about 25 μm; in some embodiments, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm. In some embodiments, the photoactive compound particles have a size distribution of ±100% of the average particle size; in some embodiments, ±90%, ±80%, ±70%, ±60%, ±50%, ±40%, ±30%, ±20%, ±10%.

In some embodiments, the fiducials, after heating and optionally irradiating, comprise from about 10 wt % to about 80 wt % photoactive compound. In some embodiments, the fiducials, after heating and optionally irradiating, comprise about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 22 wt %, about 24 wt %, about 26 wt %, about 28 wt %, about 30 wt %, about 35 wt %, about 40 wt %, about 45 wt %, about 50 wt %, about 55 wt %, about 60 wt %, about 65 wt %, about 70 wt %, about 75 wt %, or about 80 wt % photoactive compound, or any other value or range of values therein. In certain embodiments, the fiducials are convex dots, and the convex dots, after heating and optionally irradiating comprise from about 40 wt % to about 70 wt % photoactive compound. In certain embodiments, the fiducials are convex dots, and the convex dots, after heating and optionally irradiating comprise about 40 wt %, about 45 wt %, about 50 wt %, about 55 wt %, about 60 wt %, about 65 wt %, or about 70 wt % photoactive compound.

In some embodiments, the one or more photoactive compounds absorb light having a wavelength of from about 200 nm to about 1 μm. In some embodiments, the one or more photoactive compounds absorb light having a wavelength of from about 200 nm, about 220 nm, about 240 nm, about 260 nm, about 280 nm, about 300 nm, about 320 nm, about 340 nm, about 360 nm, about 380 nm, about 400 nm, about 420 nm, about 440 nm, about 460 nm, about 480 nm, about 500 nm, about 520 nm, about 540 nm, about 560 nm, about 580 nm, about 600 nm, about 620 nm, about 640 nm, about 660 nm, about 680 nm, about 700 nm, about 720 nm, about 740 nm, about 760 nm, about 780 nm, about 800 nm, about 820 nm, about 840 nm, about 860 nm, about 880 nm, about 900 nm, about 920 nm, about 940 nm, about 960 nm, about 980 nm, about 1 μm.

In some embodiments, the photoactive compound emits light having a wavelength of from about 700 nm to about 1 μm. In some embodiments, the photoactive compound emits light having a wavelength of about 700 nm, about 720 nm, about 740 nm, about 760 nm, about 780 nm, about 800 nm, about 820 nm, about 840 nm, about 860 nm, about 880 nm, about 900 nm, about 920 nm, about 940 nm, about 960 nm, about 980 nm, or about 1 μm.

In some embodiments, the photoactive compound exhibits a Stokes shift of at least about 100 nm. In certain embodiments, the photoactive compound exhibits a Stokes shift of from about 100 nm to about 800 nm. In some embodiments, the photoactive compound exhibits a Stokes shift of about 100 nm, about 125 nm, about 150 nm, about 175 nm, about 200 nm, about 225 nm, about 250 nm, about 275 nm, about 300 nm, about 325 nm, about 350 nm, about 375 nm, about 400 nm, about 425 nm, about 450 nm, about 475 nm, about 500 nm, about 525 nm, about 550 nm, about 575 nm, about 600 nm, about 625 nm, about 650 nm, about 675 nm, about 700 nm, about 725 nm, about 750 nm, about 775 nm, or about 800 nm. In some embodiments, the light absorbed and emitted by the photoactive compound does not have the same wavelength.

FIG. 1 is a plot of the absorption and emission spectra of an illustrative photoactive compound. The abscissa shows relative intensity, the ordinate is wavelength of light in nm. As shown in FIG. 1, the photoactive compound exhibits an absorption maximum at about 378 nm, and emission maxima at about 830 nm and 870 nm.

FIG. 2 is a plot of the absorption spectrum of another illustrative photoactive compound. The abscissa shows relative intensity, the ordinate is wavelength of light in nm. As shown in FIG. 2, the photoactive compound exhibits absorption maxima at about 585 nm, about 750 nm, and about 800 nm.

FIG. 3 is a plot of the emission spectrum of another illustrative photoactive compound. The abscissa shows relative intensity, the ordinate is wavelength of light in nm. As shown in FIG. 3, the photoactive compound exhibits emission maximum at about 980 nm.

In some embodiments, the photoactive compound has a quantum yield of from about 1% to about 25%; in some embodiments, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, or about 25%.

In some embodiments, the photoactive compound scatters light. In certain embodiments, the scattered light has a wavelength of from about 200 nm to about 1 μm; in some embodiments, about 200 nm, about 220 nm, about 240 nm, about 260 nm, about 280 nm, about 300 nm, about 320 nm, about 340 nm, about 360 nm, about 380 nm, about 400 nm, about 420 nm, about 440 nm, about 460 nm, about 480 nm, about 500 nm, about 520 nm, about 540 nm, about 560 nm, about 580 nm, about 600 nm, about 620 nm, about 640 nm, about 660 nm, about 680 nm, about 700 nm, about 720 nm, about 740 nm, about 760 nm, about 780 nm, about 800 nm, about 820 nm, about 840 nm, about 860 nm, about 880 nm, about 900 nm, about 920 nm, about 940 nm, about 960 nm, about 980 nm, or about 1 μm.

In some embodiments, the carrier is substantially transparent to visible light. In some embodiments, the carrier that is substantially transparent to light is greater than about 99% transparent to visible light, about 99% transparent to visible light, about 98% transparent to visible light, about 97% transparent to visible light, about 96% transparent to visible light, about 95% transparent to visible light, about 94% transparent to visible light, about 93% transparent to visible light, about 92% transparent to visible light, about 91% transparent to visible light, about 90% transparent to visible light, about 89% transparent to visible light, about 88% transparent to visible light, about 87% transparent to visible light, about 86% transparent to visible light, about 85% transparent to visible light, about 84% transparent to visible light, about 83% transparent to visible light, about 82% transparent to visible light, about 81% transparent to visible light, about 80% transparent to visible light, about 79% transparent to visible light, about 78% transparent to visible light, about 77% transparent to visible light, about 76% transparent to visible light, about 75% transparent to visible light, about 74% transparent to visible light, about 73% transparent to visible light, about 72% transparent to visible light, about 71% transparent to visible light, about 70% transparent to visible light, or any other value or range of values therein.

FIG. 4 is a schematic of an illustrative convex dot fiducial in a light-interacting pattern disposed on a substrate of the present invention. Convex dot 410 is disposed on substrate 420. Convex dot 420 comprises carrier 430, and photoactive compound 440 is distributed in carrier 430. Convex dot 410 has a height 450 and a diameter 460.

In some embodiments, the present light-interacting pattern comprising fiducials as described herein can further comprise a predetermined pattern. In some embodiments, the predetermined pattern is a randomly generated pattern, which can be reproduced to provide a known pattern having a random spatial orientation and of fiducials. In other embodiments, the predetermined pattern comprises a substantially uniform pattern. For example, the light-interacting pattern can comprise fiducials in a regular array (e.g., a grid having a regular spacing between fiducials). Any pattern that can be detected by an optical tracking system of an electronic pen or stylus can be employed. Thus, the pattern can comprise a grid of, e.g., one or more rectangles, triangles, squares, parallelograms, rhombi, pentagons, hexagons, heptagons, octagons, or combinations thereof.

In another embodiment, the light-interacting pattern comprises fiducials that have a concave morphology. Thus, in some embodiments, the fiducials are concave dots that are present in a surface of the substrate. Fiducials that have a concave morphology can be formed in a surface of the substrate by well-know techniques. For example, a surface of the substrate can be masked with a photoresist, and a predetermined pattern as described herein can be formed in the photoresist layer. The developed pattern can then be removed, and the surface can be etched to form convex dots in a surface of the substrate. The photoresist can then be stripped, leaving the substrate with the predetermined pattern of concave dots formed therein. In other embodiments, embossing can be employed to form concave fiducials.

In one embodiment, after forming concave dots in a surface of the substrate as described above, the concave dots can be filled with one or both of a carrier and photoactive compound, in some embodiments, as a mixture, as described herein. For example, a mixture of carrier, photoactive compound, optionally additives and optionally one or more solvents can be applied to a surface of the substrate having concave features formed therein. The mixture can be deposited on a surface of the substrate as described herein with respect to the deposition of convex fiducials. In some embodiments, the mixture is applied after etching of the substrate to form the concave fiducials, but prior to stripping of the photoresist. Thus, the concave features can be filled, and a convex fiducial can be formed thereon (e.g., as described herein), which will remain on the surface of the substrate after the photoresist is stripped from the surface of the substrate.

Depositing can be accomplished by, e.g., inkjet printing, screen printing, gravure printing, offset printing, flexographic printing, spray-coating, slit coating, extrusion coating, meniscus coating, microspotting, pen-coating, stenciling, stamping, syringe dispensing and/or pump dispensing the mixture onto the substrate.

Adding one or more photoactive compounds to the concave fiducials on the substrate thus can include printing a mixture comprising the carrier, one or more photoactive compounds and optionally one or more solvents and one or more additives (e.g., as described herein) to the fiducials, and drying or curing the pattern by heating. The fiducial pattern can be heated at a temperature of from about 25° C. to about 140° C.; in some embodiments, about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 105° C., about 110° C., about 115° C., about 120° C., about 125° C., about 130° C., about 135° C., or about 140° C., for a length of time effective to remove the solvent and/or to polymerize the carrier. For example, in some embodiments, the fiducial pattern can be heated for about 1 minute, about 2 minutes, about 3 minutes, about 4 minutes, about 5 minutes, about 10 minutes, about 20 minutes, about 30 minutes, about 40 minutes, about 50 minutes, about 60 minutes, about 90 minutes, about 120 minutes, about 150 minutes, about 180 minutes, about 270 minutes, about 360 minutes, or any other value or range of values therein. In some embodiments, each of the concave fiducials is at least partially filled. In some embodiments, the concave fiducials fully filled. In some embodiments, the fiducials are fully filled, and the surface of the carrier material is flush with the surface of the substrate.

In some embodiments, printing or otherwise depositing the mixture can be accompanied by irradiation with light (e.g., UV light), generally at a wavelength and/or in an intensity and for a duration to cure, polymerize or cross-polymerize carrier monomers, in embodiments wherein the carrier is deposited as one or more monomers.

The fiducials in the light-interacting pattern are disposed on a surface of the substrate. Thus, in one embodiment, the fiducials are disposed on a top surface of the substrate. In other embodiments, the fiducials are disposed on a bottom surface of the substrate.

In some embodiments, the concave fiducials have a substantially circular plan geometry. In some embodiments, the concave fiducials have an average diameter of from about 40 μm to about 150 μm; in some embodiments, each of the concave fiducials has an average diameter of about 45 μm, about 50 μm, about 55 μm, about 60 μm, about 65 μm, about 70 μm, about 75 μm, about 80 μm, about 85 μm, about 90 μm, about 95 μm, about 100 μm, about 105 μm, about 110 μm, about 115 μm, about 120 μm, about 125 μm, about 130 μm, about 135 μm, about 140 μm, about 145 μm, about 150 μm, or any other value or range of values therein.

In some embodiments, the concave fiducials have a concave spherical cap geometry, and each concave spherical cap fiducial has an average diameter of from about 40 μm to about 150 μm; in some embodiments, each of the concave fiducials has an average diameter of about 45 μm, about 50 μm, about 55 μm, about 60 μm, about 65 μm, about 70 μm, about 75 μm, about 80 μm, about 85 μm, about 90 μm, about 95 μm, about 100 μm, about 105 μm, about 110 μm, about 115 μm, about 120 μm, about 125 μm, about 130 μm, about 135 μm, about 140 μm, about 145 μm, about 150 μm, or any other value or range of values therein. In some embodiments, the fiducials are concave dots, and each of the convex dots has an average diameter of about 70 μm.

In some embodiments, the fiducials have a cylindrical geometry, and each cylindrical fiducial has an average diameter of from about 40 μm to about 150 μm; in some embodiments, each of the concave fiducials has an average diameter of about 45 μm, about 50 μm, about 55 μm, about 60 μm, about 65 μm, about 70 μm, about 75 μm, about 80 μm, about 85 μm, about 90 μm, about 95 μm, about 100 μm, about 105 μm, about 110 μm, about 115 μm, about 120 μm, about 125 μm, about 130 μm, about 135 μm, about 140 μm, about 145 μm, about 150 μm, or any other value or range of values therein.

In some embodiments, the concave fiducials have a depth of from about 1 μm to about 50 μm; in some embodiments, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm, about 40 μm, about 41 μm, about 42 μm, about 43 μm, about 44 μm, about 45 μm, about 46 μm, about 47 μm, about 48 μm, about 49 μm, about 50 μm, or any other value or range of values therein. In some embodiments, the fiducials are concave dots, and each of the concave dots has an average depth of about 5 μm to about 20 μm.

In some embodiments, the ratio of the average depth of the fiducials to the average diameter the concave dots is from about 1:20 to about 1:1; in some embodiments, about 1:20, about 1:19, about 1:18, about 1:17, about 1:16, about 1:15, about 1:14, about 1:13, about 1:12, about 1:11, about 1:10, about 1:9, about 1:8, about 1:7, about 1:6, about 1:5, about 1:4, about 1:3, about 1:2, or about 1:1.

In some embodiments, the average spacing between any two concave fiducials is from about 100 μm to about 400 μm. For example, in some embodiments, the average spacing between any two concave fiducials is about 100 μm, about 110 μm, about 120 μm, about 130 μm, about 140 μm, about 150 μm, about 160 μm, about 170 μm, about 180 μm, about 190 μm, about 200 μm, about 210 μm, about 220 μm, about 230 μm, about 240 μm, about 250 μm, about 260 μm, about 270 μm, about 280 μm, about 290 μm, about 300 μm, about 310 μm, about 320 μm, about 330 μm, about 340 μm, about 350 μm, about 360 μm, about 370 μm, about 380 μm, about 390 μm, about 400 μm, or any other value or range of values therein. In some embodiments, the fiducials are concave dots, and the average spacing between each any two concave fiducials is about 300 μm.

In some embodiments, the film comprises a first coating. The first coating can be disposed a surface of the substrate. The first coating can function as one or more of an anti-reflection layer, a polarizing layer, an infrared ray shielding layer, an anti-glare layer, an anti-static layer, and a surface protecting layer. Accordingly, the first coating can alter the brightness, luminosity, reflectance or saturation of a display to which the present film is applicable, and further, can protect the display from electromagnetic radiation. The first coating can be applied to cover at least a portion of the substrate or the light-interacting pattern disposed on or formed in the substrate. The first coating can be applied after formation of the light-interacting pattern on the substrate.

Various compounds can be employed to form the first coating. For example, the first coating can comprise an organic polymer, an inorganic polymer, or combinations thereof. In some embodiments, the first coating comprises an acrylic polymer, a urethane-based polymer, a vinyl chloride-based polymer, a melamine-based polymer, an organic silicate polymer, a silicone-based polymer, a metal oxide type compound, and combinations thereof. In some embodiments, the first coating comprises a UV-cured acrylic polymer. Such UV-cured acrylic polymers can provide a relatively simple process for curing the first coating; the transparency of such polymers is generally is excellent; and such UV-cured acrylic polymers generally display good adhesion to biaxially stretched polyester and other materials suitable for use in the present substrate.

A UV-curable acrylic polymer can be formed, e.g., by admixing an acrylic monomer (e.g., as described herein) and a photoinitiator or photosensitizer, in a solvent or diluent. Acrylic polymers suitable for the first coating can include acrylic copolymers, urethane acrylic polymers, epoxy acrylic polymers, polyether acrylic polymers and combinations thereof.

The first coating can be formed by applying to the substrate having the light-interacting pattern thereon a first coating in the form of a pre-formed sheet, which can include an adhesive. In other embodiments, the first coating can be formed by applying to the substrate an oligomer and a polymerization initiator, e.g., a photoinitiator or photosensitizer, in a solvent or diluent to the surface of the substrate, then curing or heating to form the first coating.

In some embodiments, the first coating is applied as a sheet, with an adhesive to adhere the first coating to the substrate having the light-interacting pattern thereon. Various kinds of adhesives can be used in adhering the first coating to the substrate having the light-interacting pattern thereon. In some embodiments, the adhesive is a UV-curable adhesive.

The first coating can be applied using inkjet printing, gravure printing, bar coating, die coating, or spray coating. The first coating can also be applied by immersion, flow, or spin coating. In some embodiments, the surface of the substrate, having the light-interacting pattern thereon, can be pre-treated to improve the adhesion characteristics thereof prior to formation of the first coating thereon. For example, pre-treatment can include application or treatment with a primer, an organic solvent, an acidic solution, an alkaline solution, or a mechanical or other preparation such as grinding, brushing, or irradiation including electron beam irradiation, UV irradiation, radiation treatment (e.g., with α-rays or γ-rays), or corona discharge.

In some embodiments, the first coating comprises a material (e.g., a polymer or oligomer as described herein) that absorbs or reflects UV light having a wavelength of less than about 200 nm. In some embodiments, the first coating exhibits lipophobic properties (e.g., the first coating does not absorb oils, fats or oil from skin and/or fingerprints), which can aid in preventing fingerprint marks or in the removal thereof.

In some embodiments, the first coating is substantially transparent to light having a wavelength of from about 200 nm to about 1 μm. For example, in certain embodiments, the first coating is greater than about 99% transparent to light having a wavelength of from about 200 nm to about 1 μm, about 99% transparent to light having a wavelength of from about 200 nm to about 1 μm, about 98% transparent to light having a wavelength of from about 200 nm to about 1 μm, about 97% transparent to light having a wavelength of from about 200 nm to about 1 μm, about 96% transparent to light having a wavelength of from about 200 nm to about 1 μm, about 95% transparent to light having a wavelength of from about 200 nm to about 1 μm, about 94% transparent to light having a wavelength of from about 200 nm to about 1 μm, about 93% transparent to light having a wavelength of from about 200 nm to about 1 μm, about 92% transparent to light having a wavelength of from about 200 nm to about 1 μm, about 91% transparent to light having a wavelength of from about 200 nm to about 1 μm, about 90% transparent to light having a wavelength of from about 200 nm to about 1 μm, about 89% transparent to light having a wavelength of from about 200 nm to about 1 μm, about 88% transparent to light having a wavelength of from about 200 nm to about 1 μm, about 87% transparent to light having a wavelength of from about 200 nm to about 1 μm, about 86% transparent to light having a wavelength of from about 200 nm to about 1 μm, about 85% transparent to light having a wavelength of from about 200 nm to about 1 μm, about 84% transparent to light having a wavelength of from about 200 nm to about 1 μm, about 83% transparent to light having a wavelength of from about 200 nm to about 1 μm, about 82% transparent to light having a wavelength of from about 200 nm to about 1 μm, about 81% transparent to light having a wavelength of from about 200 nm to about 1 μm, about 80% transparent to light having a wavelength of from about 200 nm to about 1 μm, about 79% transparent to light having a wavelength of from about 200 nm to about 1 μm, about 78% transparent to light having a wavelength of from about 200 nm to about 1 μm, about 77% transparent to light having a wavelength of from about 200 nm to about 1 μm, about 76% transparent to light having a wavelength of from about 200 nm to about 1 μm, about 75% transparent to light having a wavelength of from about 200 nm to about 1 μm, about 74% transparent to light having a wavelength of from about 200 nm to about 1 μm, about 73% transparent to light having a wavelength of from about 200 nm to about 1 μm, about 72% transparent to light having a wavelength of from about 200 nm to about 1 μm, about 71% transparent to light having a wavelength of from about 200 nm to about 1 μm, about 70% transparent to light having a wavelength of from about 200 nm to about 1 μm, or any other value or range of values therein.

In some embodiments, the first coating has a thickness of from about 0.5 μm to about 20 μm; in some embodiments, about 0.5 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, or about 20 μm. In some embodiments, the first coating has a thickness of about 7 μm.

In some embodiments, the first coating is chemically resistant. For example, in some embodiments, the first coating is not substantially degraded or chemically altered, e.g., oxidized, by contact with air, water, alkaline solutions, e.g., about pH 8, about pH 9, or about pH 10 solutions, acidic solutions, e.g., about pH 6, about pH 5, or about pH 4 solutions, organic solvents (e.g., hydrocarbon, alcohol, ester and ether solvents, or fingerprints.

The first coating typically displays a minimum hardness, to provide durability to the present films comprising the first coating. Thus, in some embodiments, the first coating has a hardness of from 3H to 6H as determined by ASTM D3363—Method of Test for Film Hardness by Pencil Test; in some embodiments, a hardness of 3H, 4H, 5H or 6H. In one embodiment, the first coating has a hardness of 4H as determined by ASTM D3363—Method of Test for Film Hardness by Pencil Test.

To provide a user experience that more closely simulates a “pencil and paper” feel in electronic drawing systems employing an electronic pen or stylus and the present films, the first coating can also comprise particles to provide surface friction, e.g., roughness. Thus, in some embodiments, the first coating comprises particles. In certain embodiments, the particles are that of an inorganic compound. In some embodiments, the inorganic compound is silica or alumina.

In some embodiments, the particles have an average diameter of from about 100 nm to about 5 μm; in some embodiments, about 100 nm, about 200 nm, about 300 nm, about 400 nm, about 500 nm, about 600 nm, about 700 nm, about 800 nm, about 900 nm, about 1 μm, about 1.1 μm, about 1.2 μm, about 1.3 μm, about 1.4 μm, about 1.5 μm, about 1.6 μm, about 1.7 μm, about 1.8 μm, about 1.9 μm, about 2 μm, about 2.1 μm, about 2.2 μm, about 2.3 μm, about 2.4 μm, about 2.5 μm, about 2.6 μm, about 2.7 μm, about 2.8 μm, about 2.9 μm, about 3 μm, about 3.1 μm, about 3.2 μm, about 3.3 μm, about 3.4 μm, about 3.5 μm, about 3.6 μm, about 3.7 μm, about 3.8 μm, about 3.9 μm, about 4 μm, about 4.1 μm, about 4.2 μm, about 4.3 μm, about 4.4 μm, about 4.5 μm, about 4.6 μm, about 4.7 μm, about 4.8 μm, about 4.9 μm or about 5.0 μm.

In other embodiments, the particles have an average diameter of from about 100 nm to about 500 nm, from about 500 nm to about 1 μm, from about 1 μm to about 1.5 μm, from about 1.5 μm to about 2 μm, from about 2 μm to about 2.5 μm, from about 2.5 μm to about 3 μm, from about 3 μm to about 3.5 μm, from about 3.5 μm to about 4 μm, from about 4 μm to about 4.5 μm, or from about 4.5 μm to about 5 μm. In still other embodiment, the particles have an average diameter of from about 100 nm to about 1 μm, from about 1 μm to about 2 μm, from about 2 μm to about 3 μm, from about 3 μm to about 4 μm, or from about 4 μm to about 5 μm.

The loading of particles, when in the first film, can be selected based on a desired surface friction, and other properties (e.g., transparency, mechanical strength of the first coating with a selected particle loading). Thus, in some embodiments, the first coating comprises from about 1 wt % to about 15 wt % of the particles; in some embodiments, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %.

Since the present film can be applied to a display surface, the composition of the first coating can provide desired optical properties. For example, in some embodiments, the first coating has an index of refraction of from about 1.1 to about 1.8; in some embodiments, about 1.1, about 1.15, about 1.2, about 1.25, about 1.3, about 1.35, about 1.4, about 1.45, about 1.5, about 1.55, about 1.6, about 1.65, about 1.7, about 1.75, or about 1.8. In certain embodiments, the first coating has an index of refraction of about 1.5.

In some embodiments, the first coating has a transmittance for light having a wavelength of from about from 200 nm to about 1 Lm of from about 85% to about 95%; in some embodiments, about 85%, about 86%, about 87%, about 88%, about 89%, about 90%, about 91%, about 92%, about 93%, about 94%, or about 95%. In some embodiments, the first coating has a transmittance for light having a wavelength of from about from 200 nm to about 1 μm of about 90%.

In some embodiments, the first coating has a transmittance for visible light of from about 85% to about 99%; in some embodiments, about 85%, about 86%, about 87%, about 88%, about 89%, about 90%, about 91%, about 92%, about 93%, about 94%, about 95%, about 96%, about 97%, about 98%, about 99%. In one embodiment, the first coating has a visible transmittance of about 95%.

To provide a user experience simulating a “pencil and paper” feel in electronic drawing systems employing the present films having a first coating disposed thereon, in some embodiments the first coating has a surface roughness (Ra) of from about 0.1 microinches to about 50 microinches; in some embodiments, about 0.1 microinch, about 0.5 microinches, about 1 microinches, about 5 microinches, about 10 microinches, about 15 microinches, about 20 microinches, about 25 microinches, about 30 microinches, about 25 microinches, about 40 microinches, about 45 microinches, or about 50 microinches.

In some embodiments, the present film further comprises a mask. Many handheld electronic devices include a touch screen and a perimeter area around the touch screen which can act as a housing and provide mechanical support to the touch screen. Accordingly, the present film can be configured to such that, when the film comprising the mask is adhered to a surface of a computer or handheld electronic device, the mask covers at least a portion of the surface of a computer or handheld electronic device to which the film is adhered. In some embodiments, where the film is adhered to the face of a computer or device with a touch-sensitive screen, the mask is configured such that it does not cover the touch-sensitive screen, but substantially covers a perimeter area around the touch sensitive screen.

The present films can be provided with a mask to conform to the borders of a touch screen or a device such that the transparent portions of the film (e.g., those which do not include a mask layer) are unobscured by the mask, while the non-functional portions of the device (e.g., those portions outside the touch screen area) are covered by the mask.

In some embodiments, the mask comprises a coloring agent. Computers and handheld electronic devices can be obtained in colors such as white, black, red, blue, green, yellow, and combinations and variations thereof. Accordingly, to match the color of a device to which the present films can be adhered, the mask can include a pigment such that the color of the mask matches or approximates the color of the device to which a film comprising the mask is adhered. In some embodiments, the mask is substantially opaque to visible light. In certain embodiments, the substrate is substantially transparent to visible light. “Substantially opaque to visible light” means that substantially no light in the visible spectrum, e.g., light having a wavelength of from about 400 nm to about 700 nm, passes through the mask. In some embodiments, the mask comprises a black coloring agent. In other embodiments, the mask comprises a white coloring agent. The mask can comprise any suitable polymer or resin, including an organic polymer, an inorganic polymer, or combinations thereof. For example, the mask can comprise a polyester, an acrylic polymer, a polycarbonate polymer, an acrylic resin, or any other film-forming material.

The mask can be affixed to the present film with an adhesive, e.g., as described herein). In some embodiments, the mask is affixed to the film such that when the film, comprising the mask, is adhered to the face of a device, the mask is positioned between the face of the device and the substrate. In other embodiments, the mask is affixed to the film such that when the film, comprising the mask, is adhered to the face of a device, the mask is positioned on top of the substrate.

In some embodiments, the film further comprises an adhesive layer. The adhesive can be a self-wetting adhesive. In other embodiments, the adhesive layer can include a pressure-sensitive adhesive. In certain embodiments, the adhesive layer is disposed on the mask. An adhesive having sufficient adhesiveness can be selected to mount the film onto a device, while enabling later removal without leaving adhesive residue on the device. In illustrative embodiments, the adhesive comprises silica, polyurethane, resins, organic polymers, inorganic polymers, fluorocarbon polymers, or combinations thereof. In other embodiments, the film does not comprise an adhesive layer, and can be adhered to a device by, e.g., a static electric charge.

The present films can become soiled, e.g., with fingerprints, during use (e.g, while affixed to the surface of a device). Accordingly, the adhesive layer can be selected such that the adhesive layer retains its adhesive properties after being applied to a surface then removed therefrom. For example, if the present film becomes soiled, it is desirable to remove any foreign material adhered to the surface of the film by, for example washing the film and reapplying it to the surface of the computer of handheld electronic device. Accordingly, in some embodiments, the adhesive layer is water resistant. The thickness of the adhesive layer, at any point in the layer, can range from about 0.1 μm to about 50 μm; in some embodiments, about 0.1 μm, about 0.2 μm, about 0.3 μm, about 0.4 μm, about 0.5 μm, about 0.6 μm, about 0.7 μm, about 0.8 μm, about 0.9 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 am, about 31 am, about 32 am, about 33 μm, about 34 μm, about 35 am, about 36 am, about 37 μm, about 38 μm, about 39 μm, about 40 μm, about 41 μm, about 42 μm, about 43 μm, about 44 μm, about 45 μm, about 46 μm, about 47 am, about 48 am, about 49 μm, about 50 μm.

In some embodiments, the adhesive layer has a substantially uniform thickness. For example, the thickness of the adhesive can vary less than about ±10%, less than about ±9%, less than about ±8%, less than about ±7%, less than about ±6%, less than about ±5%, less than about ±4%, less than about ±3%, less than about ±2%, less than about ±1%, less than about ±0.5%, less than about ±0.1%, or any other value or range of values therein or therebelow.

In other embodiments, the adhesive layer is tapered from the exterior portion of the mask to the interior portion of the mask. Thus, in some embodiments, the average thickness of the exterior edge of the adhesive layer is from about 25 μm to about 5 μm; in some embodiments, about 25 μm, about 24 μm, about 23 lμm, about 22 μm, about 21 μm, about 20 μm, about 19 μm, about 18 μm, about 17 μm, about 16 μm, about 15 μm, about 14 μm, about 13 lμm, about 12 lμm, about 11 μm, about 10 μm, about 9 μm, about 8 μm, about 7 μm, about 6 am, about 5 μm. In certain embodiments, the average thickness of the interior edge of the adhesive layer is from about 5 μm to about 0.1 μm; in some embodiments, about 5 am, about 4 μm, about 3 μm, about 2 μm, about 1 μm, about 0.9 μm, about 0.8 μm, about 0.7 μm, about 0.6 μm, about 0.5 μm, about 0.4 am, about 0.3 μm, about 0.2 am, about 0.1 am.

In some embodiments, the present film can comprise a second coating. For example, in certain embodiments, the film comprises a substrate having a light-interacting pattern disposed thereon, and each face of the substrate (e.g., the face having the light-interacting pattern disposed thereon and the face without a light-interacting pattern disposed thereon) can have a first and second coating, respectively.

The second coating can function as one or more of an anti-reflection layer, a polarizing layer, an infrared ray shielding layer, an anti-glare layer, an anti-static layer, and a surface protecting layer. Accordingly, the second coating can alter the brightness, luminosity, reflectance or saturation of a display to which the present film is applied, and further, can protect the display from electromagnetic radiation. The second coating can be applied to cover the substrate and the light-interacting pattern disposed on or formed in the substrate. The second coating can be applied after formation of the light-interacting pattern on the substrate.

Various materials can be employed to form the second coating. For example, the second coating can comprise an organic polymer, an inorganic polymer, or combinations thereof. In some embodiments, the second coating comprises an acrylic polymer, a urethane-based polymer, a vinyl chloride-based polymer, a melamine-based polymer, an organic silicate polymer, a silicone-based polymer, a metal oxide type compound, and combinations thereof. In some embodiments, a UV-cured acrylic polymer can be employed. Such UV-cured acrylic polymers can provide a relatively simple process for curing the second coating, the transparency of such polymers is generally is excellent, and such UV-cured acrylic polymers generally display good adhesion to biaxially stretched polyester and other materials suitable for the present substrate.

A UV-curable acrylic polymer can be formed by combining an acrylic monomer (e.g., as described herein) and a photoinitiator or photosensitizer, in a solvent or diluent. Acrylic polymers suitable for the second coating can include acrylic copolymers, urethane acrylic polymers, epoxy acrylic polymers, polyether acrylic polymers and combinations thereof.

The second coating can be formed by applying to the substrate a second coating in the form of a pre-formed sheet, which can include an adhesive. In other embodiments, the second coating can be formed by applying to the substrate an oligomer and a polymerization initiator, e.g., a photoinitiator or photosensitizer, in a solvent or diluent to a surface of the substrate, then curing or heating to form the second coating.

In some embodiments, the second coating is applied as a sheet, with an adhesive to adhere the second coating to the substrate having the light-interacting pattern thereon. Various kinds of adhesives can be used in adhering the second coating to the substrate having the light-interacting pattern thereon. In some embodiments, the adhesive is a UV-curable adhesive.

The second coating can be applied using inkjet printing, gravure printing, bar coating, die coating, or spray coating. The second coating can also be applied by immersion, flow, or spin coating. In some embodiments, the surface of the substrate can be pre-treated to improve the adhesion characteristics of the substrate prior to formation of the second coating thereon. For example, pre-treatment can include application of or treatment with a primer, an organic solvent, an acidic solution, an alkaline solution, or mechanical or other preparation such as grinding, brushing, or irradiation including electron beam irradiation, UV irradiation, radiation treatment (e.g., with α-rays or γ-rays), or corona discharge.

In some embodiments, the second coating comprises a material (e.g., a polymer or oligomer as described herein) that absorbs or reflects UV light having a wavelength of less than about 200 nm. In some embodiments, the second coating exhibits lipophobic properties (e.g., the second coating does not absorb oils, fats or oil from skin and/or fingerprints), which can aid in preventing fingerprint marks or in the removal thereof.

In some embodiments, the second coating is substantially transparent to light having a wavelength of from about 200 nm to about 1 μm. For example, in certain embodiments, the second coating is greater than about 99% transparent to light having a wavelength of from about 200 nm to about 1 μm, about 99% transparent to light having a wavelength of from about 200 nm to about 1 μm, about 98% transparent to light having a wavelength of from about 200 nm to about 1 μm, about 97% transparent to light having a wavelength of from about 200 nm to about 1 μm, about 96% transparent to light having a wavelength of from about 200 nm to about 1 μm, about 95% transparent to light having a wavelength of from about 200 nm to about 1 μm, about 94% transparent to light having a wavelength of from about 200 nm to about 1 μm, about 93% transparent to light having a wavelength of from about 200 nm to about 1 μm, about 92% transparent to light having a wavelength of from about 200 nm to about 1 μm, about 91% transparent to light having a wavelength of from about 200 nm to about 1 μm, about 90% transparent to light having a wavelength of from about 200 nm to about 1 μm, about 89% transparent to light having a wavelength of from about 200 nm to about 1 μm, about 88% transparent to light having a wavelength of from about 200 nm to about 1 μm, about 87% transparent to light having a wavelength of from about 200 nm to about 1 μm, about 86% transparent to light having a wavelength of from about 200 nm to about 1 μm, about 85% transparent to light having a wavelength of from about 200 nm to about 1 μm, about 84% transparent to light having a wavelength of from about 200 nm to about 1 μm, about 83% transparent to light having a wavelength of from about 200 nm to about 1 μm, about 82% transparent to light having a wavelength of from about 200 nm to about 1 μm, about 81% transparent to light having a wavelength of from about 200 nm to about 1 μm, about 80% transparent to light having a wavelength of from about 200 nm to about 1 μm, about 79% transparent to light having a wavelength of from about 200 nm to about 1 μm, about 78% transparent to light having a wavelength of from about 200 nm to about 1 μm, about 77% transparent to light having a wavelength of from about 200 nm to about 1 μm, about 76% transparent to light having a wavelength of from about 200 nm to about 1 μm, about 75% transparent to light having a wavelength of from about 200 nm to about 1 μm, about 74% transparent to light having a wavelength of from about 200 nm to about 1 μm, about 73% transparent to light having a wavelength of from about 200 nm to about 1 μm, about 72% transparent to light having a wavelength of from about 200 nm to about 1 μm, about 71% transparent to light having a wavelength of from about 200 nm to about 1 μm, about 70% transparent to light having a wavelength of from about 200 nm to about 1 μm, or any other value or range of values therein.

In some embodiments, the second coating has a thickness of from about 0.5 μm to about 20 μm; in some embodiments, about 0.5 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, or about 20 μm.

In some embodiments, the second coating is chemically resistant. For example, in some embodiments, the second coating is not substantially degraded or chemically altered, e.g., oxidized, by contact with air, water, alkaline solutions, e.g., about pH 8, about pH 9, or about pH 10 solutions, acidic solutions, e.g., about pH 6, about pH 5, or about pH 4 solutions, organic solvents, e.g., hydrocarbon, alcohol, ester and ether solvents, or fingerprints.

Since the present film can be applied to a display surface, the composition of the second coating can be selected to provide desired optical properties. For example, in some embodiments, the second coating has an index of refraction of from about 1.1 to about 1.8; in some embodiments, about 1.1, about 1.15, about 1.2, about 1.25, about 1.3, about 1.35, about 1.4, about 1.45, about 1.5, about 1.55, about 1.6, about 1.65, about 1.7, about 1.75, or about 1.8. In certain embodiments, the second coating has an index of refraction of about 1.5.

In some embodiments, the second coating has a transmittance for light having a wavelength of from about from 200 nm to about 1 μm of from about 85% to about 95%; in some embodiments, about 85%, about 86%, about 87%, about 88%, about 89%, about 90%, about 91%, about 92%, about 93%, about 94%, or about 95%. In some embodiments, the second coating has a transmittance for light having a wavelength of from about from 200 nm to about 1 μm of about 90%.

In some embodiments, the second coating has a transmittance for visible light of from about 85% to about 99%; in some embodiments, about 85%, about 86%, about 87%, about 88%, about 89%, about 90%, about 91%, about 92%, about 93%, about 94%, about 95%, about 96%, about 97%, about 98%, about 99%. In one embodiment, the second coating has a visible transmittance of about 95%.

In some embodiments, the light-interacting pattern can be disposed on a bottom surface of the substrate, e.g., the light-interacting pattern is disposed on the proximal face of the substrate, which is nearest the computer or handheld device. Accordingly, in some embodiments, to direct and/or reflect light emitted by the photoactive compound toward the surface of the film where the stylus or pen can detect such light, the film can further comprise a reflective layer disposed below the light-interacting pattern, configured to reflect light emitted by the photoactive compound. For example, in some embodiments, the reflective layer can be disposed between the substrate and the second coating. In other embodiments, the reflective layer can be disposed between the substrate and the mask.

Various materials can be employed to form the reflective layer. For example, the reflective layer can comprise an organic polymer, an inorganic polymer, one or more metals, or combinations thereof. In some embodiments, the reflective layer comprises an acrylic polymer, a urethane-based polymer, a vinyl chloride-based polymer, a melamine-based polymer, an organic silicate polymer, a silicone-based polymer, a metal oxide type compound, and combinations thereof. In some embodiments, a UV-cured acrylic polymer can be employed. Such UV-cured acrylic polymers can provide a relatively simple process for curing the reflective layer, the visible light transparency of such polymers is generally is excellent, and such UV-cured acrylic polymers generally display good adhesion to biaxially stretched polyester and other materials suitable for the present substrate.

A UV-curable acrylic polymer can be formed by combining an acrylic monomer (e.g., as described herein) and a photoinitiator or photosensitizer, in a solvent or diluent. Acrylic polymers suitable for the reflective layer can include acrylic copolymers, urethane acrylic polymers, epoxy acrylic polymers, polyether acrylic polymers and combinations thereof.

The reflective layer can be formed by applying the reflective layer to the substrate in the form of a pre-formed sheet, which can include an adhesive. In other embodiments, the reflective layer can be formed by applying the acrylic oligomer and a photoinitiator or photosensitizer, in a solvent or diluent to a surface of the substrate, then curing or heating to form the reflective layer.

In some embodiments, the reflective layer is applied as a sheet, with an adhesive to adhere the reflective layer to the substrate. Various kinds of adhesives can be used in adhering the reflective layer to the substrate. In some embodiments, the adhesive is a UV-curable adhesive.

The reflective layer can be applied using inkjet printing, gravure printing, bar coating, die coating, or spray coating. The reflective layer can also be applied by immersion, flow, or spin coating. In some embodiments, the surface of the substrate can be pre-treated to improve the adhesion characteristics of the substrate prior to formation of the reflective layer. For example, pre-treatment can include application of or treatment with a primer, an organic solvent, an acidic solution, an alkaline solution, or mechanical or other preparation such as grinding, brushing, or irradiation including electron beam irradiation, UV irradiation, radiation treatment (e.g., with α-rays or γ-rays), or corona discharge.

In some embodiments, the reflective layer comprises one or more metals. The one or more metals can be deposited by, e.g., physical vapor deposition or chemical vapor deposition. The one or more metals can include, e.g., silver, gold, rhodium, ruthenium, osmium, platinum, palladium, copper, silicon, cadmium, tin, lithium, nickel, cobalt, manganese, indium, chromium, antimony, gallium, boron, molybdenum, zirconium, beryllium, titanium, aluminum, germanium and zinc, or mixtures thereof.

In some embodiments, the reflective layer comprises a material (e.g., a polymer, oligomer or additive) that reflects certain wavelengths of light. For example, in certain embodiments, the reflective layer reflects at least about 10% of light having a wavelength of from about 200 nm to about 400 nm and/or from about 700 nm to about 1 μm; in some embodiments, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, or any other value or range of values therein. In one embodiment, the reflective layer reflects at least about 50% of light having a wavelength of from about 200 nm to about 400 nm and/or from about 700 nm to about 1 μm. In one embodiment, the reflective layer reflects at least about 50% of light having a wavelength of from about 200 nm to about 400 nm. In one embodiment, the reflective layer reflects at least about 50% of light having a wavelength of from about 700 nm to about 1 μm.

In some embodiments, the reflective layer is substantially transparent to visible light. In some embodiments, the reflective layer can be greater than about 99% transparent to visible light, about 99% transparent to visible light, about 98% transparent to visible light, about 97% transparent to visible light, about 96% transparent to visible light, about 95% transparent to visible light, about 94% transparent to visible light, about 93% transparent to visible light, about 92% transparent to visible light, about 91% transparent to visible light, about 90% transparent to visible light, about 89% transparent to visible light, about 88% transparent to visible light, about 87% transparent to visible light, about 86% transparent to visible light, about 85% transparent to visible light, about 84% transparent to visible light, about 83% transparent to visible light, about 82% transparent to visible light, about 81% transparent to visible light, about 80% transparent to visible light, about 79% transparent to visible light, about 78% transparent to visible light, about 77% transparent to visible light, about 76% transparent to visible light, about 75% transparent to visible light, about 74% transparent to visible light, about 73% transparent to visible light, about 72% transparent to visible light, about 71% transparent to visible light, about 70% transparent to visible light, or any other value or range of values therein.

In some embodiments, the reflective layer has a thickness of from about 0.1 μm to about 25 μm; in some embodiments, about 0.1 μm, about 0.2 μm, about 0.3 μm, about 0.4 μm, about 0.5 μm, about 0.6 μm, about 0.7 μm, about 0.8 μm, about 0.9 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, or about 25 μm.

In some embodiments, the reflective layer is also chemically resistant. For example, in some embodiments, the reflective layer is not substantially degraded or chemically altered, e.g., oxidized, by contact with air, water, alkaline solutions, e.g., about pH 8, about pH 9, or about pH 10 solutions, acidic solutions, e.g., about pH 6, about pH 5, or about pH 4 solutions, organic solvents, e.g., hydrocarbon, alcohol, ester and ether solvents, or fingerprints.

Since the present film can be applied to a display surface, the composition of the reflective layer can provide desired optical properties. For example, in some embodiments, the reflective layer has an index of refraction of from about 1.1 to about 1.8; in some embodiments, about 1.1, about 1.15, about 1.2, about 1.25, about 1.3, about 1.35, about 1.4, about 1.45, about 1.5, about 1.55, about 1.6, about 1.65, about 1.7, about 1.75, or about 1.8.

In some embodiments, the reflective layer has a transmittance for visible light of from about 70% to about 99%; in some embodiments, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%. In one embodiment, the reflective layer has a visible light transmittance of about 95%.

In some embodiments, the reflective layer substantially covers a surface of the substrate. “Substantially covers” means that the reflective layer covers at least about 95% of a surface of substrate, at least about 96% of a surface of substrate, at least about 97% of a surface of substrate, at least about 98% of a surface of substrate, or at least about 99% of a surface of substrate.

The present films, once constructed, can be configured to adhere to the outer surface of a display screen of a computer or hand-held electronic device. Accordingly, the film can be constructed, then cut to fit a specific model or type of computer or handheld device. Where a device, e.g., a handheld tablet computer or smartphone, has one or more buttons or switches on the face of the device to which the film is to be applied, portions of the film that correspond to the location of such buttons or switches can be removed, e.g., by forming “cutouts”. Cutting of the manufactured film can be performed by, e.g., punch or die-cutting.

The present films can be applied to a computer or handheld device having a touch-sensitive screen that is configured to receive user input via an object capable of contacting the touch-sensitive screen. In some embodiments, the object can interact with the film by emitting light. In some embodiments, the object does not contact the touch sensitive screen. In some embodiments, the film extends beyond the periphery of the touch sensitive screen. In certain embodiments, the film is configured to substantially cover the outer surface of the touch-sensitive screen. To allow for viewing of the screen to which the film is applied through the film, the film can have particular optical properties. For example, in some embodiments, the film has an index of refraction of from about 1.1 to about 1.8; in some embodiments, about 1.1, about 1.15, about 1.2, about 1.25, about 1.3, about 1.35, about 1.4, about 1.45, about 1.5, about 1.55, about 1.6, about 1.65, about 1.7, about 1.75, or about 1.8.

Films as described herein can have essentially any desired size, and can be configured, e.g., cut, to fit a specific device or class of devices. For example, a film can have a length of from about 10 cm to about 100 cm; in some embodiments, about 10 cm, about 11 cm, about 12 cm, about 13 cm, about 14 cm, about 15 cm, about 16 cm, about 17 cm, about 18 cm, about 19 cm, about 20 cm, about 21 cm, about 22 cm, about 23 cm, about 24 cm, about 25 cm, about 26 cm, about 27 cm, about 28 cm, about 29 cm, about 30 cm, about 35 cm, about 40 cm, about 45 cm, about 50 cm, about 55 cm, about 60 cm, about 65 cm, about 70 cm, about 75 cm, about 80 cm, about 85 cm, about 90 cm, about 95 cm, or about 100 cm.

The film can have a width of from about 10 cm to about 100 cm; in some embodiments, about 10 cm, about 11 cm, about 12 cm, about 13 cm, about 14 cm, about 15 cm, about 16 cm, about 17 cm, about 18 cm, about 19 cm, about 20 cm, about 21 cm, about 22 cm, about 23 cm, about 24 cm, about 25 cm, about 26 cm, about 27 cm, about 28 cm, about 29 cm, about 30 cm, about 35 cm, about 40 cm, about 45 cm, about 50 cm, about 55 cm, about 60 cm, about 65 cm, about 70 cm, about 75 cm, about 80 cm, about 85 cm, about 90 cm, about 95 cm, or about 100 cm.

The film can have a thickness of from about 100 μm to about 200 μm; in some embodiments, about 100 μm, about 105 μm, about 110 μm, about 115 μm, about 120 μm, about 125 gμm, about 130 μm, about 135 μm, about 140 μm, about 145 μm, about 150 μm, about 155 μm, about 160 μm, about 165 μm, about 170 gμm, about 175 μm, about 180 μm, about 185 μm, about 190 μm, about 195 μm, or about 200 μm. In certain embodiments, the film has a thickness of about 135 μm. In some embodiments, e.g., where the present film is applied to a capacitive touch screen of a computer or handheld device, the thickness of the film can be selected such that the film does not substantially interfere with the operation of the capacitive touch screen.

The present films, when applied to a touch screen device, can allow for user input to be transferred through the film to the touch screen. Thus, in some embodiments, an object can be employed for facilitating user input to the touch screen via a film as described herein. In some embodiments, the object is a stylus or a user's finger. In some embodiments, at least some of the force, substantially all of the force, or all of the force imparted by the object is transferred to the touch-sensitive screen through the film.

In certain embodiments, the object is a stylus that comprises a light source capable of emitting light having a wavelength of from about 200 nm to about 1 μm; in some embodiments, about e.g., about 200 nm, about 220 nm, about 240 nm, about 260 nm, about 280 nm, about 300 nm, about 320 nm, about 340 nm, about 360 nm, about 380 nm, about 400 nm, about 420 nm, about 440 nm, about 460 nm, about 480 nm, about 500 nm, about 520 nm, about 540 nm, about 560 nm, about 580 nm, about 600 nm, about 620 nm, about 640 nm, about 660 nm, about 680 nm, about 700 nm, about 720 nm, about 740 nm, about 760 nm, about 780 nm, about 800 nm, about 820 nm, about 840 nm, about 860 nm, about 880 nm, about 900 nm, about 920 nm, about 940 nm, about 960 nm, about 980 nm, about 1 μm.

In some embodiments, the stylus comprises a detector capable of detecting light, e.g., light emitted from the photoactive compound, having a wavelength of from about 200 nm to about 1 μm; in some embodiments, about 200 nm, about 220 nm, about 240 nm, about 260 nm, about 280 nm, about 300 nm, about 320 nm, about 340 nm, about 360 nm, about 380 nm, about 400 nm, about 420 nm, about 440 nm, about 460 nm, about 480 nm, about 500 nm, about 520 nm, about 540 nm, about 560 nm, about 580 nm, about 600 nm, about 620 nm, about 640 nm, about 660 nm, about 680 nm, about 700 nm, about 720 nm, about 740 nm, about 760 nm, about 780 nm, about 800 nm, about 820 nm, about 840 nm, about 860 nm, about 880 nm, about 900 nm, about 920 nm, about 940 nm, about 960 nm, about 980 nm, about 1 μm.

The present films, when constructed, can further comprise a removable protective cover or backing, to protect the face or adhesive during handling, packaging or shipping, until the film is applied to a computer or handheld device. Thus, films as described herein can further comprise one or more removable protective layers capable of protecting the face or exposed adhesive layer. The protective layer can include a tab to assist in the removal of the protective layer prior to applying the film to a device.

FIG. 5 shows a cross-sectional view of a portion of an illustrative film of the present invention. Film 510 comprises substrate 520, with a light-interacting pattern comprising convex dots 530 disposed on a surface of substrate 520. First coating 540 is disposed on and substantially covers a light-interacting pattern comprising convex dots 530. Mask 550 is disposed on the lower surface of substrate 520, and adhesive layer 560 is disposed on the lower surface of mask 550.

FIG. 6 shows a cross-sectional view of a portion of another illustrative film of the present invention. Film 610 comprises substrate 620, with a light-interacting pattern comprising convex dots 630 disposed on a bottom surface of substrate 620. First coating 640 is disposed on and substantially covers a top surface of substrate 620. Mask 650 is disposed on the lower surface of substrate 620, and adhesive layer 660 is disposed on the lower surface of mask 650.

FIG. 7 shows a cross-sectional view of a portion of another illustrative film of the present invention. Film 710 comprises substrate 720, with a light-interacting pattern comprising convex dots 730 disposed on a bottom surface of substrate 720. First coating 740 is disposed on and substantially covers light-interacting pattern comprising convex dots 730 and the bottom surface of substrate 720. Mask 750 is disposed on the lower surface of substrate 720, and adhesive layer 760 is disposed on the lower surface of mask 750. Second coating 770 is disposed on and substantially covers a top surface of substrate 720.

FIG. 8 shows a cross-sectional view of a portion of another illustrative film of the present invention. Film 810 comprises substrate 820, with a light-interacting pattern comprising convex dots 830 disposed on a bottom surface of substrate 820. First coating 840 is disposed on and substantially covers light-interacting pattern comprising convex dots 830 and the bottom surface of substrate 820. Reflective layer 850 is disposed on and substantially covers a bottom surface of substrate 820. Mask 860 is disposed on the lower surface of reflective layer 850, and adhesive layer 870 is disposed on the lower surface of mask 860.

FIG. 9 shows a cross-sectional view of a portion of another illustrative film of the present invention. Film 910 comprises substrate 920, with a light-interacting pattern comprising concave dots 930 disposed in a top surface of substrate 920. First coating 940 is disposed on and substantially covers light-interacting pattern comprising concave dots 930. Mask 950 is disposed on the lower surface of substrate 920, and adhesive layer 960 is disposed on the lower surface of mask 950.

In some embodiments, the present film can be part of a system. For example, in some embodiments, the present invention provides a system including a computer or hand-held electronic device. A computer or handheld device can include a tablet computer, a personal data assistant, a cellular phone, a handheld video game console, a desktop computer, or a laptop computer. The computer or hand-held device can comprise a display screen, which can be a touch-sensitive screen. A film as described herein can be affixed or adhered to the touch sensitive screen, thereby providing the system including a film of the present invention. In some embodiments, the system further comprises a stylus configured to emit light to and detect light scattered by or reflected from the light-interacting pattern of the film. In some embodiments, the system further comprises a transmitting device coupled to the stylus, and configured to transmit data from the stylus to the computer or hand-held electronic device. In certain embodiments, the present invention also provides a computer or hand-held electronic device including a touch-sensitive display screen and a film as described herein, wherein the film is adhered to the touch-sensitive screen.

For example, the system can include a stylus including a housing and an image sensor that is coupled to the housing and that has a field of view. The stylus also includes a non-imaging optical system coupled to the housing and disposed outside of the field of view of the image sensor. The non-imaging optical system can output diffuse light in a set of directions to a surface to produce scattered light. The image sensor and the non-imaging optical system are collectively configured such that during operation, the image sensor receives at least a portion of the scattered light.

In other embodiments, the stylus includes a housing and an image sensor that is coupled to the housing. The stylus also includes a non-imaging optical system coupled to the housing that can output light to a surface and produce a scattered light component and a specular reflected light component. The image sensor and the non-imaging optical system are collectively configured in such a manner that during operation, the image sensor receives from a surface (1) at least a portion of the scattered light component and not the specular reflected light component or (2) at least a portion of the scattered light component having a magnitude and at least a portion of the specular reflective light component having a magnitude less than the magnitude of the portion of the scattered light component. In some embodiments, the system is contained within a sealed or sealable package.

In still another embodiment, the present invention comprises a computer system, including a film as described herein, a computer or hand-held electronic device touch-sensitive display screen, a stylus configured to emit light to and detect light scattered by or reflected from the light-interacting pattern of the film, and a transmitting device coupled to the stylus and configured to transmit data from the stylus to the computer or hand-held electronic device.

In another embodiment, the present invention provides a method for transmitting data from a stylus to a computer or hand-held device. The method includes allowing a stylus to emit light to and detect light scattered by, emitted by or reflected from a light-interacting pattern of a film of as described herein, the film being adhered to a touch-sensitive screen of a computer or hand-held electronic device, and the stylus being coupled to a transmitting device, and allowing the transmitting device to transmit data from the stylus to the computer or hand-held electronic device.

The embodiments described herein should be understood to be illustrative of the present invention, and should not be construed as limiting. On the contrary, the present disclosure embraces alternatives and equivalents thereof, as embodied by the appended claims. Each reference disclosed herein is incorporated by reference herein in its entirety.

What is claimed is:

1. A film, comprising:
a. a substrate; and
b. a light-interacting pattern;
wherein the film is substantially transparent to visible light.

2. The film of claim 1, wherein the film is configured to adhere to the outer surface of a display screen of a computer or hand-held electronic device.

3. The film of claim 2, wherein the display screen comprises a touch-sensitive screen that is configured to receive user input via an object.

4. The film of claim 3, wherein the object is in contact with the touch sensitive screen.

5. The film of claim 3, wherein the object does not contact with the touch sensitive screen.

6. The film of claim 3, wherein the object is capable of emitting light.

7. The film of claim 3, wherein the film extends beyond the periphery of the touch sensitive screen.

8. The film of claim 2, configured to substantially cover the outer surface of the touch-sensitive screen.

9. The film of claim 1, wherein the film has a length of from about 10 cm to about 100 cm.

10. The film of claim 1, wherein the film has a width of from about 10 cm to about 100 cm.

11. The film of claim 1, wherein the film has a thickness of from about 100 μm to about 200 μm.

12. The film of claim 1, wherein the film has a thickness of about 135 μm

13. The film of claim 3, wherein the object is a stylus or a user's finger.

14. The film of claim 3, wherein the object is a stylus that comprises a light source capable of emitting light having a wavelength of from about 200 nm to about 1 μm.

15. The film of claim 14, wherein the stylus comprises a detector capable of detecting light having a wavelength of from about 200 nm to about 1 μm.

16. The film of claim 3, wherein substantially all of the force imparted by the object is transferred to the touch-sensitive screen.

17. The film of claim 1, wherein the film has an index of refraction of from about 1.3 to about 1.8.

18. The film of claim 1, wherein the light-interacting pattern comprises a plurality of fiducials.

19. The film of claim 18, wherein the fiducials are convex dots.

20. The film of claim 19, wherein each of the convex dots comprises a carrier and a photoactive compound.

21. The film of claim 18, wherein the fiducials are disposed on a surface of the substrate.

22. The film of claim 19, wherein each of the convex dots has a substantially circular plan geometry.

23. The film of claim 19, wherein each of the convex dots has an average diameter of from about 40 μm to about 150 μm.

24. The film of claim 19, wherein each of the convex dots has an average diameter of about 70 μm.

25. The film of claim 19, wherein each of the convex dots has an average height of from about 5 μm to about 20 μm.

26. The film of claim 19, wherein each of the convex dots has an average height of about 9 μm.

27. The film of claim 19, wherein the ratio of the average height of the convex dots to the average diameter the convex dots is from about 1:10 to about 1:4.

28. The film of claim 18, wherein the fiducials have a spatial density of from about 10 dots per inch (dpi) to about 300 dpi.

29. The film of claim 18, wherein the average spacing between each fiducial is from about 100 μm to about 400 μm.

30. The film of claim 18, wherein the average spacing between each fiducial is about 300 μm.

31. The film of claim 20, wherein the carrier comprises an organic polymer, an inorganic polymer, a polysiloxane polymer, or mixtures thereof.

32. The film of claim 31, wherein the organic polymer is an acrylate polymer.

33. The film of claim 20, wherein the carrier has an index of refraction of from about 1.1 to about 1.5.

34. The film of claim 20, wherein the photoactive compound absorbs light, and emits light responsive to absorption of the light.

35. The film of claim 34, wherein the photoactive compound absorbs light having a wavelength of from about 200 nm to about 1 μm.

36. The film of claim 34, wherein the photoactive compound emits light having a wavelength of from about 0.7 μm to about 1 μm

37. The film of claim 20, wherein the photoactive compound exhibits a Stokes shift of at least about 100 nm.

38. The film of claim 20, wherein the photoactive compound has a quantum yield of from about 1% to about 15%.

39. The film of claim 20, wherein the convex dots comprise from about 10 wt % to about 80 wt % of the photoactive compound.

40. The film of claim 20, wherein the convex dots comprise from about 40 wt % to about 70 wt % of the photoactive compound.

41. The film of claim 20, wherein the photoactive compound scatters light.

42. The film of claim 41, wherein the scattered light has a wavelength of from about 200 nm to about 1 μm.

43. The film of claim 20, wherein the carrier is substantially transparent to visible light.

44. The film of claim 1, wherein the light-interacting pattern comprises a predetermined pattern.

45. The film of claim 44, wherein the predetermined pattern comprises a random pattern.

46. The film of claim 44, wherein the predetermined pattern comprises a substantially uniform pattern.

47. The film of claim 18, wherein the fiducials are concave dots present on a surface of the substrate.

48. The film of claim 47, wherein the each of the concave dots comprises a carrier and a photoactive compound.

49. The film of claim 47, wherein each of the concave dots has a substantially circular plan geometry.

50. The film of claim 47, wherein each of the concave dots has an average diameter of from about 40 μm to about 150 μm.

51. The film of claim 47, wherein each of the concave dots has an average diameter of about 70 μm.

52. The film of claim 47, wherein each of the concave dots has an average depth of from about 1 μm to about 50 μm.

53. The film of claim 47, wherein the ratio of the average depth of the concave dots to the average diameter the concave dots is from about 1:10 to about 1:2.

54. The film of claim 47, wherein the concave dots are present in a spatial density of from about 10 to about 300 dpi.

55. The film of claim 47, wherein the spacing between any two of the concave dots is from about 100 μm to about 400 μm.

56. The film of claim 47, wherein the spacing between any two of the concave dots is about 300 μm.

57. The film of claim 1, further comprising a first coating.

58. The film of claim 57, wherein the first coating comprises a material that absorbs UV light having a wavelength of less than about 200 nm.

59. The film of claim 57, wherein the first coating comprises a lipophobic material.

60. The film of claim 57, wherein the first coating is substantially transparent to light having a wavelength of from about 200 nm to about 1 μm.

61. The film of claim 57, wherein the first coating comprises an organic polymer, an inorganic polymer, or combinations thereof.

62. The film of claim 61, wherein the organic polymer is an acrylic polymer.

63. The film of claim 57, wherein the first coating has a thickness of from about 0.5 μm to about 20 μm.

64. The film of claim 57, wherein the first coating has a thickness of about 7 μm.

65. The film of claim 57, wherein the first coating is chemically resistant or comprises a chemically resistant coating.

66. The film of claim 57, wherein the first coating has a hardness of from 3H to 6H as determined by ASTM D3363—Method of Test for Film Hardness by Pencil Test.

67. The film of claim 66, wherein the first coating has a hardness of 4H as determined by ASTM D3363—Method of Test for Film Hardness by Pencil Test.

68. The film of claim 57, wherein the first coating comprises particles.

69. The film of claim 68, wherein the particles are of an inorganic compound.

70. The film of claim 69, wherein the inorganic compound is silica or alumina.

71. The film of claim 69, wherein the particles have an average diameter of from about 100 nm to about 5 μm.

72. The film of claim 68, wherein the first coating comprises from about 1 wt % to about 15 wt % of the particles.

73. The film of claim 57, wherein the first coating has an index of refraction of from about 1.3 to about 1.8.

74. The film of claim 57, wherein the first coating has an index of refraction of about 1.5.

75. The film of claim 57, wherein the first coating has a visible transmittance of from about 85% to about 95%.

76. The film of claim 57, wherein the first coating has a visible transmittance of about 90%.

77. The film of claim 57, wherein the first coating has a visible transmittance of about 95%.

78. The film of claim 57, wherein the first coating has a surface roughness (Rₐ) of from about 0.1 microinch to about 50 microinches.

79. The film of claim 3, further comprising a mask.

80. The film of claim 79, wherein the mask is configured to substantially cover at least a portion of the outer surface of the display screen of a computer or hand held electronic device that does not include the touch-sensitive screen.

81. The film of claim 79, wherein the mask comprises a coloring agent.

82. The film of claim 79, wherein the mask is substantially opaque to visible light.

83. The film of claim 81, wherein the coloring agent is black.

84. The film of claim 81, wherein the coloring agent is white.

85. The film of claim 79, wherein the mask comprises an organic polymer, an inorganic polymer, or combinations thereof.

86. The film of claim 1, wherein the substrate comprises an adhesive layer.

87. The film of claim 86, wherein the adhesive layer comprises a self-wetting adhesive.

88. The film of claim 79, wherein an adhesive layer is disposed on the mask.

89. The film of claim 86, wherein the adhesive layer comprises silica, polyurethane, or combinations thereof.

90. The film of claim 86, wherein the adhesive layer retains its adhesive properties after being applied to a surface then removed therefrom.

91. The film of claim 86, wherein the adhesive layer is water resistant.

92. The film of claim 86, wherein the adhesive layer has an average thickness of from about 0.1 μm to about 50 μm.

93. The film of claim 86, wherein the adhesive layer has a substantially uniform thickness.

94. The film of claim 88, wherein the adhesive layer is tapered from the exterior portion of the mask to the interior portion of the mask.

95. The film of claim 92, wherein the average thickness of the exterior edge of the adhesive layer is from about 25 μm to about 5 μm.

96. The film of claim 92, wherein the average thickness of the interior edge of the adhesive layer is from about 5 μm to about 0.1 μm.

97. The film of claim 1, wherein the substrate is substantially transparent to visible light.

98. The film of claim 1, wherein the substrate comprises a polymer.

99. The film of claim 98, wherein the polymer is polyethylene terepthalate, biaxially stretched polyester, or mixtures thereof.

100. The film of claim 1, wherein substrate has a thickness of from about 80 μm to about 150 μm.

101. The film of claim 1, wherein substrate has a thickness of about 125 μm.

102. The film of claim 1, further comprising a second coating.

103. The film of claim 102, wherein the second coating comprises an organic polymer, an inorganic polymer, or combinations thereof.

104. The film of claim 102, wherein the second coating is an organic polymer that is an acrylic polymer.

105. The film of claim 102, wherein the second coating has a thickness of from about 0.5 μm to about 20 μm.

106. The film of claim 102, wherein the second coating is substantially transparent to visible light.

107. The film of claim 102, wherein the second coating substantially covers a bottom surface of the substrate.

108. The film of claim 1, further comprising a reflective layer.

109. The film of claim 108, wherein the reflective layer comprises an organic polymer, an inorganic polymer, or combinations thereof.

110. The film of claim 108, wherein the reflective layer substantially covers a bottom surface of the substrate.

111. The film of claim 108, wherein the reflective layer reflects at least 50% of light having a wavelength of from about 200 nm to about 400 nm and/or from about 650 nm to about 1 μm.

112. The film of claim 108, wherein the reflective layer has a thickness of from about 0.1 μm to about 25 μm.

113. The film of claim 1, further comprising:
a light-interacting layer on a top surface of the substrate, the light-interacting layer comprising the light-interacting pattern;
a first coating substantially covering the light-interacting layer;
a mask on a bottom surface of the substrate and covering a peripheral area of the substrate; and
an adhesive layer covering at least a portion of the mask.

114. The film of claim 1, comprising:
a light-interacting layer on a bottom surface of the substrate, the light-interacting layer comprising the light-interacting pattern;
a first coating covering a top surface of the substrate;
a mask on a bottom surface of the substrate and covering a peripheral area of the substrate; and
an adhesive layer covering at least a portion of the mask.

115. The film of claim 1, comprising:
a light-interacting layer on a bottom surface of the substrate, the light-interacting layer comprising the light-interacting pattern;
a first coating covering a top surface of the substrate;
a second coating covering the light-interacting layer;
a mask on a bottom surface of the second coating and covering a peripheral area of the second coating; and
an adhesive layer covering at least a portion of the mask.

116. The film of claim 1, comprising:
a light-interacting layer on a top surface of the substrate, the light-interacting layer comprising the light-interacting pattern;
a first coating covering the light-interacting layer;
a reflective layer substantially covering a bottom surface of the substrate;
a mask on a bottom surface of the reflective layer and covering a peripheral area of the reflective layer; and
an adhesive layer covering at least a portion of the mask.

117. The film of claim 1, comprising:
a light-interacting layer on a top surface of the substrate, the light-interacting layer comprising the light-interacting pattern;
a first coating covering the light-interacting layer;
a mask on a bottom surface of the substrate and covering a peripheral area of the substrate; and
an adhesive layer covering at least a portion of the mask.

118. A system, comprising:
a computer or hand-held electronic device, the computer or hand-held device comprising a display screen, the display screen comprising a touch-sensitive screen; and
the film of claim 1.

119. A computer or hand-held electronic device, comprising:
a display screen, the display screen comprising a touch-sensitive screen; and
the film of claim 1, wherein the film is adhered to the touch-sensitive screen.

120. The system of claim 118, further comprising a stylus configured to emit light to and detect light scattered by or reflected from the light-interacting pattern of the film.

121. The system of claim 120, further comprising a transmitting device, the transmitting device being coupled to the stylus and configured to transmit data from the stylus to the computer or hand-held electronic device.

122. A computer system, comprising:
the film of claim 1;
a computer or hand-held electronic device, the computer or hand-held device comprising a display screen, the display screen comprising a touch-sensitive screen;
a stylus configured to emit light to and detect light scattered by or reflected from the light-interacting pattern of the film; and
a transmitting device, the transmitting device being coupled to the stylus and configured to transmit data from the stylus to the computer or hand-held electronic device.

123. A method for transmitting data from a stylus to a computer or hand-held device, comprising:
allowing a stylus to emit light to and detect light scattered by, emitted by or reflected from the light-interacting pattern of the film of claim 1, the film being adhered to a touch-sensitive screen of a computer or hand-held electronic device, and the stylus being coupled to a transmitting device; and
allowing the transmitting device to transmit data from the stylus to the computer or hand-held electronic device.
